(19) United States
(12) Patent Application Publication
(10) Pub. No.: US 2026/0356258 A1
(43) Pub. Date: Nov. 12, 2026

(54) CHILD SAFETY SEAT

(71) Applicant: WONDERLAND SWITZERLAND AG, Steinhausen (CH)

(72) Inventors: Gregory S. Sellers, Morgantown, PA (US); Bruce L. Williams, Morgantown, PA (US)

(21) Appl. No.: 19/130,652

(22) PCT Filed: Nov. 17, 2023
(86) PCT No.: PCT/US2023/080376

§ 371 Date: May 16, 2025

Related U.S. Application Data
(60) Provisional application No. 63/426,937, filed on Nov. 21, 2022.
(60) Provisional application No. 63/496,528, filed on Apr. 17, 2023.
(60) Provisional application No. 63/500,109, filed on May 4, 2023.
(60) Provisional application No. 63/500,798, filed on May 8, 2023.
(60) Provisional application No. 63/581,050, filed on Sep. 7, 2023.
(60) Provisional application No. 63/595,120, filed on Nov. 1, 2023.

(51) Int. Cl. B60N 2/28; B60N 2/75

(52) U.S. Cl. CPC B60N 2/2872; B60N 2/2821; B60N 2/2875; B60N 2/75; B60N 2/2806; B60N 2/2812; B60N 2/2851

(57) ABSTRACT

A child safety seat includes a seat shell having an upright support surface including a first side and a second side. A first upright side member is arranged at the first side and extends forward from the upright support surface. A second upright side member is arranged at the second side and extends forward from the upright support surface. An upright support cavity for receiving an upper body of a child is defined between the upright support surface, the first upright side member and the second upright side member. At least one armrest is located within the upright support cavity.

### CROSS REFERENCE TO RELATED APPLICATIONS

This application claims the benefit of U.S. Application No. 63/426,937, filed on Nov. 21, 2022, U.S. Application No. 63/496,528, filed on Apr. 17, 2023, U.S. Application No. 63/500,109, filed on May 4, 2023, U.S. Application No. 63/500,798, filed on May 8, 2023, U.S. Application No. 63/581,050, filed on Sep. 7, 2023, and U.S. Application No. 63/595,120, filed Nov. 1, 2023, which is incorporated herein by reference in its entirety.

### BACKGROUND

Exemplary embodiments of the disclosure relative to child safety seats for use in a vehicle.

A child safety seat is typically used in an automobile vehicle to properly restrain a child in the event of accident. The installation of the child safety seat usually requires securely attaching the child safety seat on the vehicle seat with a vehicle seatbelt or a harness separately provided. Depending on whether the child safety seat is installed in a rearward-facing or a forward-facing configuration, the vehicle seatbelt or harness is generally threaded along different paths, with the belt being properly tightened via attachment systems provided in the child safety seat. Unfortunately, the attachment systems of existing child safety seats do not allow for adjustment of the child safety seat once installed on the vehicle seat.

Therefore, there is a need for an improved child safety seat that allows convenient adjustment of the child safety seat while installed on a vehicle seat with minimal effort.

### BRIEF DESCRIPTION

According to an embodiment, a child safety seat includes a seat shell having an upright support surface including a first side and a second side. A first upright side member is arranged at the first side and extends forward from the upright support surface. A second upright side member is arranged at the second side and extends forward from the upright support surface. An upright support cavity for receiving an upper body of a child is defined between the upright support surface, the first upright side member and the second upright side member. At least one armrest is located within the upright support cavity.

In addition to one or more of the features described above, or as an alternative, in further embodiments the at least one armrest is located at the at least one of the first upright side member the second upright side member.

In addition to one or more of the features described above, or as an alternative, in further embodiments the at least one armrest is arranged at an inwardly facing surface of the at least one of the first upright side member and the second upright side member.

In addition to one or more of the features described above, or as an alternative, in further embodiments the at least one armrest further includes a support surface. The support surface is formed by a lateral offset in the inwardly facing surface of the at least one of the first upright side member and the second upright side member.

In addition to one or more of the features described above, or as an alternative, in further embodiments further including a pad mounted in overlapping arrangement with the support surface.

In addition to one or more of the features described above, or as an alternative, in further embodiments the pad protrudes in at least one direction beyond the support surface.

In addition to one or more of the features described above, or as an alternative, in further embodiments a cavity is formed in the inwardly facing surface of the at least one of the first upright side member and the second upright side member, the at least one armrest being arranged within the cavity.

In addition to one or more of the features described above, or as an alternative, in further embodiments the cavity includes a curved surface and the at least one armrest is arranged at an end of the curved surface.

In addition to one or more of the features described above, or as an alternative, in further embodiments the seat shell further includes a seat support surface including another first side and another second side. A first seat side member is arranged at the another first side and extends upward from the seat support surface and a second seat side member is arranged at the second side and extends upward from the seat support surface.

In addition to one or more of the features described above, or as an alternative, in further embodiments the first seat side member and the first upright side member are integrally formed and the second seat side member and the second upright side member are integrally formed.

In addition to one or more of the features described above, or as an alternative, in further embodiments each of the first seat side member and the second seat side member has a slot formed therein for receiving a vehicle restraint.

In addition to one or more of the features described above, or as an alternative, in further embodiments the at least one armrest is positioned behind the slot.

In addition to one or more of the features described above, or as an alternative, in further embodiments further including a seat bottom, the seat shell being permanently connected to the seat bottom.

According to an embodiment, a child safety seat includes a seat bottom, a seat shell connected to the seat bottom, and a light arranged at the seat shell.

In addition to one or more of the features described above, or as an alternative, in further embodiments the seat shell further includes an upright support surface including a first side and a second side and a first upright side member arranged at the first side and extend forward from the upright support surface. A second upright side member is arranged at the second side and extends forward from the upright support surface. The light is mounted to one of the first upright side member and the second upright side member.

In addition to one or more of the features described above, or as an alternative, in further embodiments the light is arranged at an inwardly facing surface of one of the first upright side member and the second upright side member.

In addition to one or more of the features described above, or as an alternative, in further embodiments a cavity is formed in the inwardly facing surface of the one of the first upright side member and the second upright side member. The light is arranged within the cavity.

In addition to one or more of the features described above, or as an alternative, in further embodiments the cavity includes a curved surface and the light extends over the curved surface.

In addition to one or more of the features described above, or as an alternative, in further embodiments the light is arranged adjacent to a front edge of the one of the first upright side member and the second upright side member.

In addition to one or more of the features described above, or as an alternative, in further embodiments the seat shell further comprises an upright support cavity for receiving an upper body of a child. The upright support cavity is defined between the upright support surface, the first upright side member and the second upright side member. The light is operable to illuminate the upright support cavity.

In addition to one or more of the features described above, or as an alternative, in further embodiments the light has an elongated configuration.

In addition to one or more of the features described above, or as an alternative, in further embodiments the light further comprises a plurality of lights.

According to an embodiment, a child safety seat suitable for placement on a vehicle seat includes a seat bottom, a seat shell affixed to the seat bottom and a mechanism for adjusting an incline of the child safety seat relative to the vehicle seat. The mechanism is operable while the child safety seat is secured to the vehicle seat and a vehicle seatback angle of the vehicle seat is changed.

In addition to one or more of the features described above, or as an alternative, in further embodiments at least a portion of the seat bottom is movable in response to operation of the mechanism to adjust the incline of the child safety seat.

In addition to one or more of the features described above, or as an alternative, in further embodiments the seat bottom further comprises a housing and a support member. The support member is movable relative to the housing between a first position and a second position to adjust the incline of the child safety seat.

In addition to one or more of the features described above, or as an alternative, in further embodiments in the first position, a bottom surface of the support member is flush with a bottom of the housing and in the second position, the bottom surface of the support member protrudes beyond the bottom of the housing.

In addition to one or more of the features described above, or as an alternative, in further embodiments the mechanism further includes a rack mounted to the housing. The rack includes a plurality of first teeth. A catch is movably mounted to the support member. The catch includes at least one second tooth. In both the first position and the second position, the at least one second tooth is intermeshed with the plurality of first teeth.

In addition to one or more of the features described above, or as an alternative, in further embodiments the catch is arranged at an upper surface of the support member.

In addition to one or more of the features described above, or as an alternative, in further embodiments the catch is arranged within the support member at a position adjacent to the rack.

In addition to one or more of the features described above, or as an alternative, in further embodiments further includes a biasing member for biasing the at least one second tooth of the catch into engagement with the plurality of first teeth.

In addition to one or more of the features described above, or as an alternative, in further embodiments further including an actuator positioned at an exterior surface of the child safety seat and a flexible member operably coupling the actuator to the catch. Operation of the actuator opposes a biasing force of the biasing member.

In addition to one or more of the features described above, or as an alternative, in further embodiments the actuator is positioned at the seat shell.

In addition to one or more of the features described above, or as an alternative, in further embodiments the seat shell further comprises a seat portion and an upright portion. The actuator is positioned at the upright portion.

In addition to one or more of the features described above, or as an alternative, in further embodiments the actuator is transformable between an engaged position and a released position. The mechanism further includes an actuator lock operable to selectively lock the actuator in the released position.

According to an embodiment, a method for configuring a child safety seat on a vehicle seat includes positioning the child safety seat on the vehicle seat, securing the child safety seat to the vehicle seat, and adjusting an incline of the child safety seat relative to the vehicle seat while the child safety seat is secured to the vehicle seat and a vehicle seat back angle of the vehicle seat is changed.

According to an embodiment, a child safety seat suitable for placement on a vehicle seat includes a seat bottom having a movable support member, a seat shell affixed to the seat bottom, and a mechanism for adjusting an incline of the child safety seat relative to the vehicle seat. The mechanism includes an actuator, a catch for selectively locking the support member relative to the seat bottom, and a flexible member connecting the actuator and the catch. The actuator is movable in a first direction and the flexible member is movable in a second direction in response to operation of the actuator. The second direction is arranged at an angle to the first direction.

In addition to one or more of the features described above, or as an alternative, in further embodiments the second direction is perpendicular to the first direction.

In addition to one or more of the features described above, or as an alternative, in further embodiments the first direction is lateral and the second direction is vertical.

In addition to one or more of the features described above, or as an alternative, in further embodiments the actuator is transformable between an engaged position and a released position. The mechanism further includes an actuator lock operable to selectively lock the actuator in the released position.

According to an embodiment, a child safety seat includes a seat bottom, a seat shell connected to the seat bottom, and a light removably coupled to the seat shell.

In addition to one or more of the features described above, or as an alternative, in further embodiments the light is part of an assembly and the assembly is removably coupled to the seat shell.

In addition to one or more of the features described above, or as an alternative, in further embodiments the seat shell includes a cavity and the assembly is receivable within the cavity.

In addition to one or more of the features described above, or as an alternative, in further embodiments the assembly includes a housing and a power source arranged within an interior of the housing. The power source is operably coupled to the light.

In addition to one or more of the features described above, or as an alternative, in further embodiments the power source includes a replaceable battery.

In addition to one or more of the features described above, or as an alternative, in further embodiments the power source includes a rechargeable battery.

In addition to one or more of the features described above, or as an alternative, in further embodiments the assembly includes a charging port formed in the housing.

In addition to one or more of the features described above, or as an alternative, in further embodiments including an actuator for selectively energizing the light. The actuator is arranged at an exterior of the housing.

In addition to one or more of the features described above, or as an alternative, in further embodiments including at least one another light positioned about the seat shell, the at least one another light being located remotely from the assembly.

In addition to one or more of the features described above, or as an alternative, in further embodiments the power source is operably coupled to the at least one another light when the assembly is removably coupled to the seat shell.

In addition to one or more of the features described above, or as an alternative, in further embodiments the housing includes a flexible member including a radial catch. The flexible member is biased radially outwardly.

In addition to one or more of the features described above, or as an alternative, in further embodiments the seat shell includes a support surface extending at least partially in a vertical direction from the seat bottom. The seat shell includes a side member extending from the support surface in a forward direction and the light is removably coupled to the side member.

According to an embodiment, a child safety seat including a seat bottom, a seat shell connected to the seat bottom, and a charger removably coupled to the seat shell. The charger is connectable to a portable device to charge the portable device.

In addition to one or more of the features described above, or as an alternative, in further embodiments the charger is operable to charge the portable device when the charger is separated from the seat shell.

In addition to one or more of the features described above, or as an alternative, in further embodiments the charger is operable to charge the portable device when the charger is connected to the seat shell.

In addition to one or more of the features described above, or as an alternative, in further embodiments the charger includes a housing, a power source arranged within an interior of the housing, and a charging port formed in the housing.

In addition to one or more of the features described above, or as an alternative, in further embodiments the seat shell includes a cavity and the charger is receivable within the cavity.

In addition to one or more of the features described above, or as an alternative, in further embodiments when the charger is received within the cavity, a first end of the housing is arranged within the cavity and a second end of the housing is external to the cavity, the charging port being formed at the second end of the housing.

According to an embodiment, a seat shell for a child safety seat includes a seat portion, an upright back portion extending from the seat portion, a first upright side member arranged at a first side of the upright back portion and a second upright side member arranged at a second side of the upright back portion. Each of the first and second upright side members includes a first end portion, a second end portion positioned below the first end portion, a central portion positioned between the first end portion and the second end portion, and an inwardly facing surface extending from the first end portion to the second end portion. The inwardly facing surfaces on the second end portions of the first and second upright side members are laterally offset towards an interior of the seat shell relative to the respective inwardly facing surfaces of the central portions of the first and second upright side members.

In addition to one or more of the features described above, or as an alternative, in further embodiments the second end portions of the first and second upright side members are positioned adjacent to the seat portion.

In addition to one or more of the features described above, or as an alternative, in further embodiments at least one armrest is arranged on the inwardly facing surface of at least one of the first upright side member and the second upright side member.

In addition to one or more of the features described above, or as an alternative, in further embodiments the at least one armrest is formed by the lateral offset of at least one of the inwardly facing surfaces of the second end portions.

In addition to one or more of the features described above, or as an alternative, in further embodiments a cavity is formed in a portion of at least one of the inwardly facing surface of at least one of the first upright side member and the second upright side member.

In addition to one or more of the features described above, or as an alternative, in further embodiments the cavity is formed on the central portion of at least one of the first upright side member and the second upright side member.

In addition to one or more of the features described above, or as an alternative, in further embodiments the inwardly facing surface on the central portion of at least one of the first upright side member and the second upright side member is a curved surface defining the cavity.

In addition to one or more of the features described above, or as an alternative, in further embodiments the inwardly facing surface on the central portion of at least one of the first upright side member and the second upright side member extends outwardly away from the interior of the seat shell relative to the first end portions and the second end portions.

In addition to one or more of the features described above, or as an alternative, in further embodiments the inwardly facing surface on the central portion of at least one of the first upright side member and the second upright side member extends from an approximate shoulder height of a child positioned in the child safety seat to an approximate waist height of the child seated within the child safety seat.

In addition to one or more of the features described above, or as an alternative, in further embodiments the cavity is formed between the approximate shoulder height and the approximate waist height.

According to an embodiment, a seat shell for a child safety seat includes a seat portion, an upright back portion extending from the seat portion, and at least one upright side member arranged at a side of the upright back portion. The at least one upright side member includes a first end portion, a second end portion positioned below the first end portion, a central portion positioned between the first end portion and the second end portion, and an inwardly facing surface on the first end portion and the second end portion. The inwardly facing surface on the first and the second end portions is laterally offset towards an interior of the seat shell relative to the central portion.

In addition to one or more of the features described above, or as an alternative, in further embodiments the central portion comprises at least one of a cavity and a void.

In addition to one or more of the features described above, or as an alternative, in further embodiments the central portion extends from the first end portion to the second end portion.

In addition to one or more of the features described above, or as an alternative, in further embodiments the central portion includes an inwardly facing curved surface.

In addition to one or more of the features described above, or as an alternative, in further embodiments the inwardly facing curved surface extends outwardly from the interior from the first end portion to the second end portion. The inwardly facing curved surface defines a cavity between the first end portion and the second end portion.

In addition to one or more of the features described above, or as an alternative, in further embodiments the first end portion is positioned at a first height such that when a child is positioned within the child safety seat the inwardly facing surface of the first end portion approximately aligns with a shoulder of the child. The second end portion is positioned at a second height such that when the child is positioned within the child safety seat the inwardly facing surface of the second end portion approximately aligns with a hip of the child.

In addition to one or more of the features described above, or as an alternative, in further embodiments the central portion extends from the first end portion to the second end portion and defines a cavity therebetween. The cavity is sized such that when the child is positioned within the child safety seat an arm of the child is at least partially receivable within the cavity.

In addition to one or more of the features described above, or as an alternative, in further embodiments the inwardly facing surface of at least one of the first end portion and the second end portion defines a planar surface.

According to an embodiment, a seat shell for a child safety seat includes a seat portion, an upright back portion extending from the seat portion, and at least one upright side member arranged at a side of the upright back portion. The at least one upright side member has an inwardly facing upright surface. At least one side seat member arranged at a side of the seat portion and adjacent to the at least one upright side member. The at least one side seat member has an inwardly facing side surface. The inwardly facing upright surface is laterally offset towards an interior of the seat shell relative to the inwardly facing side surface.

In addition to one or more of the features described above, or as an alternative, in further embodiments the at least one upright side member is positioned between the upright back portion and the at least one side seat member in a front direction.

According to an embodiment, a seat shell includes a seat portion, an upright back portion extending from the seat portion, at least one upright side member arranged at a side of the upright back portion, and at least one side impact protector arranged at the at least one upright side member. The at least one side impact protector extends towards an interior of the seat shell.

In addition to one or more of the features described above, or as an alternative, in further embodiments the at least one upright side member includes an upper region and a lower region. The at least one side impact protector is arranged at one of the upper region and the lower region.

In addition to one or more of the features described above, or as an alternative, in further embodiments an inwardly facing surface of the at least one side impact protector is laterally offset towards an interior of the seat shell relative to the inwardly facing surface at the at least one upright side member between the upper region and the lower region.

In addition to one or more of the features described above, or as an alternative, in further embodiments the lateral offset of the inwardly facing surface of the at least one side impact protector is formed by a contour of the seat shell.

In addition to one or more of the features described above, or as an alternative, in further embodiments soft goods are mounted to the seat shell. The lateral offset of the inwardly facing surface of the at least one side impact protector is formed by the soft goods.

In addition to one or more of the features described above, or as an alternative, in further embodiments the at least one upright side member includes a first end portion, a second end portion positioned below the first end portion, and a central portion positioned between the first end portion and the second end portion.

In addition to one or more of the features described above, or as an alternative, in further embodiments the upper region includes the first end portion.

In addition to one or more of the features described above, or as an alternative, in further embodiments the upper region additionally includes part of the central portion.

In addition to one or more of the features described above, or as an alternative, in further embodiments the lower region includes the second end portion.

In addition to one or more of the features described above, or as an alternative, in further embodiments the lower region additionally includes part of the central portion.

In addition to one or more of the features described above, or as an alternative, in further embodiments the at least one upright side member includes a first upright side member arranged at a first side of the upright back portion and a second upright side member arranged at a second side of the upright back portion. The at least one side impact protector includes a first side impact protector at the first upright side member and a second side impact protector arranged at the second upright side member.

In addition to one or more of the features described above, or as an alternative, in further embodiments the at least one side impact protector aligns with a shoulder of a child positioned within the seat shell.

In addition to one or more of the features described above, or as an alternative, in further embodiments the at least one side impact protector aligns with a hip of a child positioned within the seat shell.

### BRIEF DESCRIPTION OF THE DRAWINGS

The following descriptions should not be considered limiting in any way. With reference to the accompanying drawings, like elements are numbered alike:

FIG. 1 is a perspective view of a child safety seat according to an embodiment;

FIG. 2 is a front view of the child safety seat of FIG. 1 according to an embodiment;

FIG. 3 is another front view of the child safety seat of FIG. 1 according to an embodiment;

FIG. 4 is a rear view of the child safety seat of FIG. 1 according to an embodiment;

FIG. 5 is a perspective view of a child safety seat according to an embodiment;

FIG. 6 is a front view of the child safety seat of FIG. 5 according to an embodiment;

FIG. 7 is a side view of a child safety seat according to an embodiment;

FIG. 8 is a cross-sectional view of the child safety seat of FIG. 7 according to an embodiment;

FIG. 9 is a perspective view of a child seat having an assembly including a light according to another embodiment;

FIG. 10 is a partially exploded perspective view of the child seat of FIG. 9 according to an embodiment;

FIG. 11A is a front perspective view of an assembly including a light according to an embodiment;

FIG. 11B is a rear perspective view of an assembly including a light according to an embodiment

FIG. 12 is a cross-sectional view of the assembly of FIG. 11A according to an embodiment;

FIG. 13 is a cross-sectional view of an assembly including a light installed within the seat shell according to an embodiment;

FIG. 14 is a side view of a child seat including an assembly including a light according to an embodiment;

FIG. 15A is a cross-sectional view of a mechanism for adjusting the incline of the child safety seat in an engaged position according to an embodiment;

FIG. 15B is a cross-sectional view of the mechanism for adjusting the incline of the child safety seat of FIG. 15A in a disengaged position according to an embodiment;

FIG. 16A is a cross-sectional view of another mechanism for adjusting the incline of the child safety seat in an engaged position according to an embodiment;

FIG. 16B is a cross-sectional view of the mechanism for adjusting the incline of the child safety seat of FIG. 16A in a disengaged position according to an embodiment; and

FIG. 17 is a perspective view of an actuator of the mechanism for adjusting the incline of the child safety seat according to an embodiment;

FIG. 18 is a perspective view of another actuator of the mechanism for adjusting the incline of the child safety seat according to an embodiment;

FIG. 19 is a perspective view of the child seat having an integral harness according to an embodiment;

FIGS. 20A and 20B are side perspective view of the child seat absent the harness according to an embodiment;

FIG. 21 is a perspective view of the child seat having an open storage compartment according to an embodiment;

FIG. 22 is a detailed perspective view of the storage area of a crotch buckle of the harness according to an embodiment; and

FIGS. 23A and 23B are perspective views of a child seat, according to an embodiment of this disclosure;

FIG. 24 is a perspective view of a child seat including a side impact protector according to an embodiment; and

FIG. 25 is a perspective view of another child seat including a side impact protector according to an embodiment.

### DETAILED DESCRIPTION

A detailed description of one or more embodiments of the disclosed apparatus and method are presented herein by way of exemplification and not limitation with reference to the Figures.

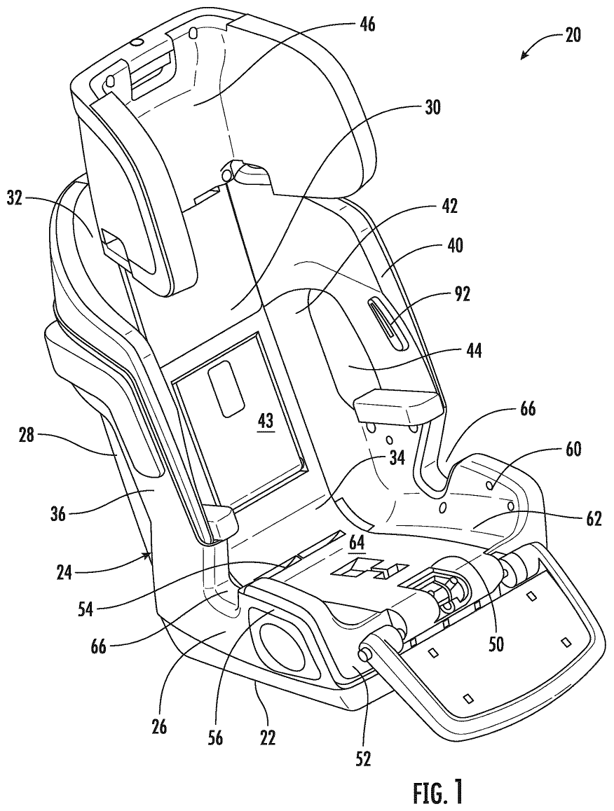

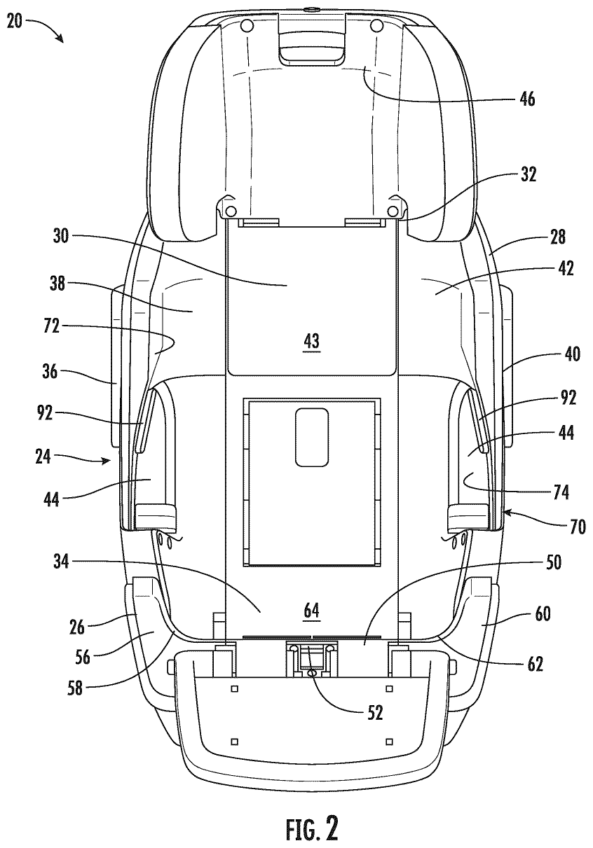

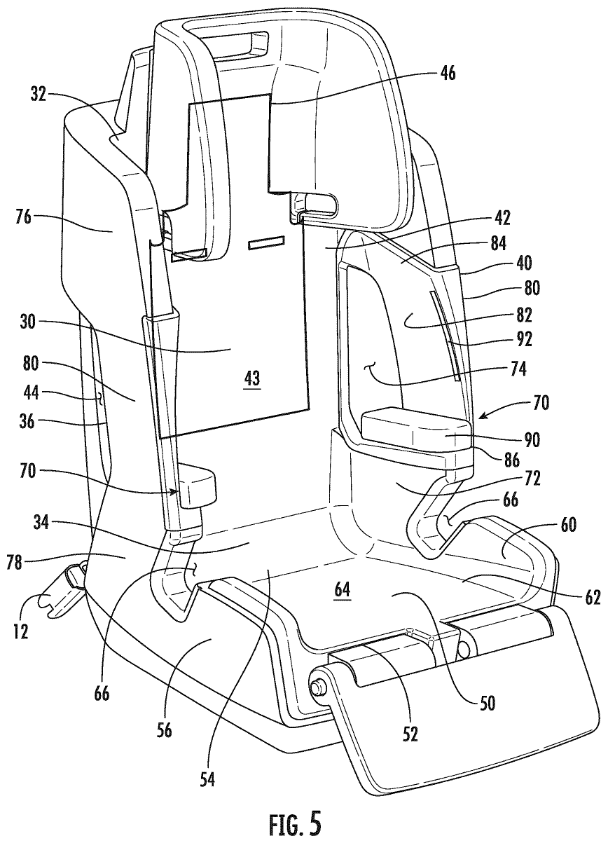

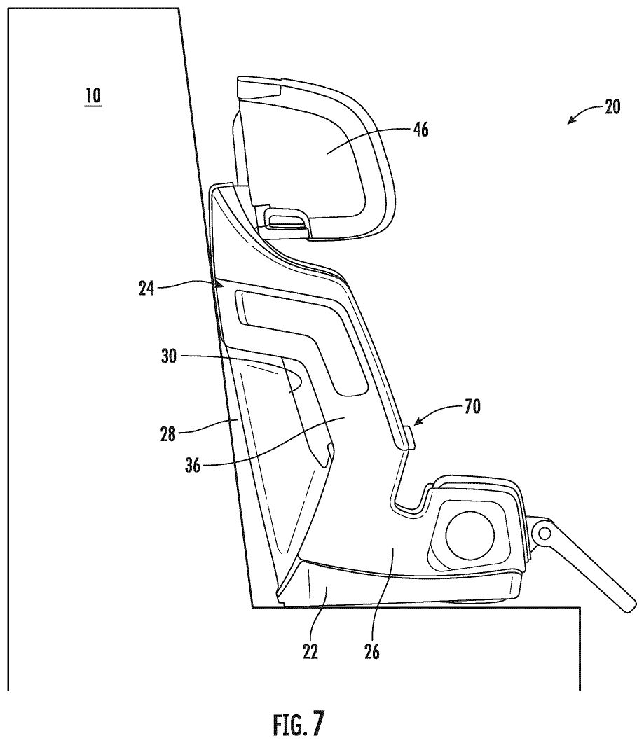

With reference now to FIGS. 1-3, a child safety seat 20 according to an embodiment is illustrated. The child safety seat 20 can be detachably fixed to a vehicle seat 10 (FIG. 7), such as via a latch or anchor mechanism 12, partially shown in FIG. 5. This latch or anchor system often used is sometimes referred to as a “lower anchor and tether for children” e.g., LATCH system. Alternatively, or in addition, as will be described in more detail below, the child safety seat 20 may be detachably fixed to a vehicle seat 10 via a vehicle belt (not shown) associated with the vehicle seat 10.

The child safety seat 20 may include a seat bottom 22 and a rigid seat shell 24 coupled to the seat bottom 22, the seat shell 24 being adapted to receive a child. In an embodiment, the seat shell 24 is detachably connected to the seat bottom 22, thereby allowing the seat shell 24 to be separated from the seat bottom 22. Alternatively, the seat bottom 22 and the seat shell 24 may be permanently connected or affixed together. As used herein the term “permanently connected” represents embodiments where the seat shell 24 is not intended to be disassembled from the seat bottom 22 by a user.

The seat shell 24 may include a seat portion 26 and a backrest or upright portion 28 arranged at an angle relative to the seat portion 26. The seat portion 26 and the upright portion 28 may be detachably coupled, or alternatively, may be permanently coupled. In the illustrated, non-limiting embodiment, the upright portion 28 and the seat portion 26 are integrally formed as a single unitary body. In another alternative aspect, the upright portion 28 can be rotationally connected to the seat portion 26 such that the upright portion 28 can incline and recline relative to the seat portion 26.

As shown, the upright portion 28 of the seat shell 24 includes an upright support surface 30 generally facing forward and that extends from a first end or top 32 to a second, opposite end or bottom 34 of the upright portion 28. A first upright side member 36 may be arranged at a first side 38 of the upright support surface 30 and a second upright side member 40 may be arranged at a second, opposite side 42 of the upright support surface 30. The first and second upright side members 36, 40 therefore form the left side and the right side of the upright portion 28, respectively. As shown, the first and second upright side members 36, 40 extend forward from the upright support surface 30. The first and second upright side members 36, 40 may extend generally orthogonally to the upright support surface 30, or alternatively, may extend therefrom at another angle, such as an angle greater than 90° for example. Accordingly, the upright support surface 30 and the first and second upright side members 36, 40 define a backrest region or upright support cavity 43 within which an upper body of a child is received.

The side members 36, 40 may facilitate the correct positioning of a vehicle belt when the child safety seat 20 is installed in a vehicle. In some embodiments, each upright side member 36, 40 has an opening 44 formed therein. The opening 44 may be configured to receive a vehicle seatbelt (not shown) to secure the child safety seat 20 to a vehicle seat in a forward-facing high-back configuration.

In the illustrated, non-limiting embodiment, the upright portion 28 of the seat shell 24 includes a headrest 46. The headrest 46 is attached to or integral with the upright portion 28. The headrest 46 may be stationary or in some embodiments, may be configured to move relative to the upright support surface 30. For example, the headrest 46 may be configured to translate relative to the upright support surface 30 between a retracted position and an extended position, allowing for adjustment based on the size of the child positioned within the child safety seat 20.

The seat portion 26 includes a seat support surface 50 facing generally upwardly and that extends from a first end or front 52 to a second end or back 54 of the seat portion 26. A first seat side member 56 may be arranged at a first side 58 of the seat support surface 50 and a second seat side member 60 may be arranged at a second, opposite side 62 of the seat support surface 50. The first seat side member 56 and the second seat side member 60 extend upwardly and form the left side and the right side of the seat portion 26. The seat support surface 50 and the first and second seat side member 56, 60 in combination define a region 64 within which at least part of a lower body of a child may be received.

As shown, the seat side members 56, 60 extend at an angle from the seat support surface 50. The angle of the first seat side member 56 relative to the seat support surface 50 may but need not be the same as the angle of the first upright side member 36 relative to the upright support surface 30. Similarly, the angle of the second seat side member 60 relative to the seat support surface 50 may but need not be the same as the angle of the second upright side member 40 relative to the upright support surface 30. In an embodiment, the first upright side member 36 and the first seat side member 56 are integrally formed and the second upright side member 40 and the second seat side member 60 are integrally formed.

In the illustrated, non-limiting embodiment, each seat side member 56, 60 has a slot 66 formed therein configured to function as a lap belt guide during at least one mode of use of the child safety seat 20. The slot 66 may be configured to receive and position a lap belt portion of a vehicle restraint or a separate restraint belt to attach the child safety seat 20 to a vehicle seat 10 when the child safety seat 20 is in a forward-facing high-back configuration as illustrated in FIG. 1.

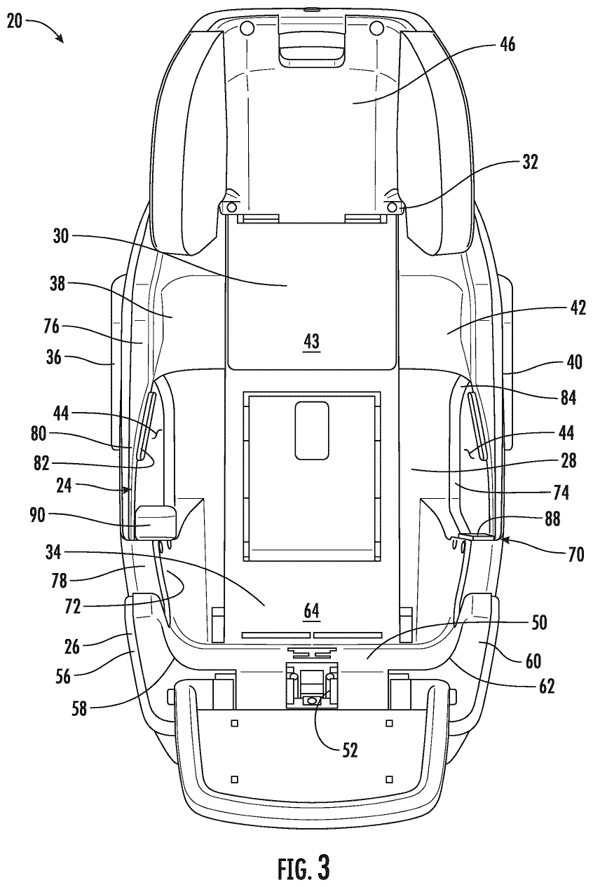

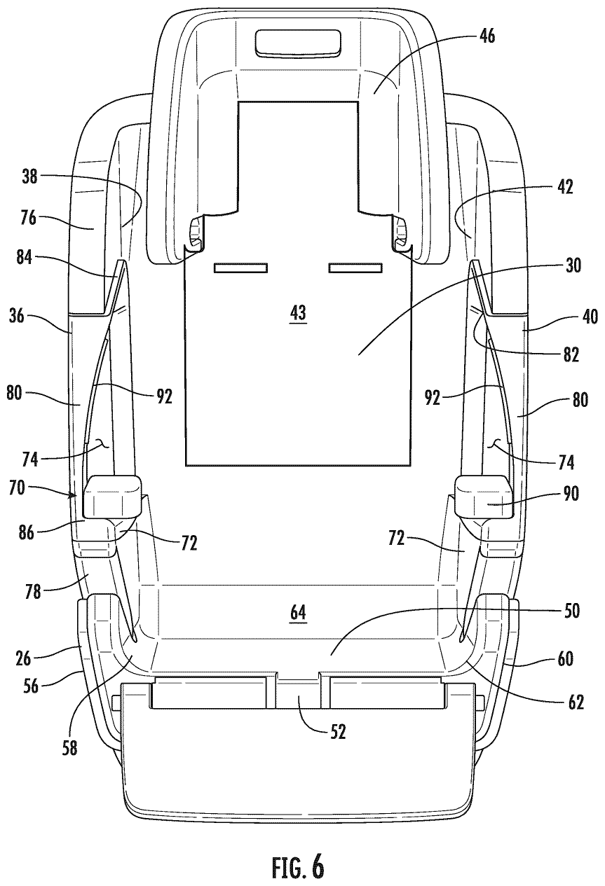

With reference to FIGS. 1-3, 5-6, and 9-10 in an embodiment, at least one armrest 70 is arranged at an interior surface of the upright portion 28, such as within the upright support cavity 43 within which an upper body of a child is received. As shown, the inwardly facing surface 72 of at least one of the first upright side member 36 and the second upright side member 40 may have a non-planar configuration. For example, a cavity or recess 74 (best shown in FIGS. 3 and 6) may be formed in a portion of the inwardly facing surface 72. In the illustrated, non-limiting embodiment, each upright side member 36, 40 has a first end portion 76 arranged near the first end 32 of the upright support surface 30, a second end portion 78 arranged near the second end 34 of the upright support surface 30, and a central portion 80 disposed between the first and second end portions 76, 78. As shown, the cavity 74 may be formed in the central portion 80. In an embodiment, the inwardly facing surface at the central portion is an arcuate or curved surface 82 defining the cavity 74. The curved surface 82 may extend from approximately shoulder height to waist height of a child seated within the child safety seat. As shown, the curved surface 82 may be concave and extending outwardly, away from the plane defined by the inwardly facing surface 72 of either the first or second end portions 76, 78. As a result, the thickness of the first and second upright side members 36, 40 may gradually reduce from a first end 84 of the central portion 80 located adjacent the first end portion 76 toward a second end 86 thereof arranged near the second end portion 78.

In an embodiment, the armrest 70 is arranged at the second end 86 of the curved surface 82, within the cavity 74. As best shown in FIG. 3, the second end 86 of the curved surface 82 is not flush with the inwardly facing surface 72 of the second end portion 78. Rather, the inwardly facing surface 72 adjacent to the second end 86 of the curved surface 82 may have a stepped configuration such that the inwardly facing surface 72 of the second end portion 78 is laterally offset, towards the interior or the child safety seat 20, from the second end 86 of the curved surface 82. This lateral offset which extends over the depth of the upright side member 36, 40 at that position, may form a shelf or support surface 88 suitable as an armrest 70. Alternatively, in an embodiment, a separate member 90, such as a pad for example, is mounted in overlapping arrangement with this support surface 88. In embodiments where a pad or other member 90 is attached to the support surface 88 to form the armrest 70, the member 90 may protrude beyond the support surface 88 in at least one direction, such as forward of the upright side members 36, 40, backward from the upright side members 36, 40 into the opening 44, and/or inwardly from the support surface 88. Locating the armrest 70 within the upright support cavity 43 provides a more ergonomic configuration for a child seated within the child safety seat 20. Further, arranging the armrest 70 vertically offset from and behind the slots 66, minimizes interference between the armrest and the positioning of the vehicle restraint within the slots 66.

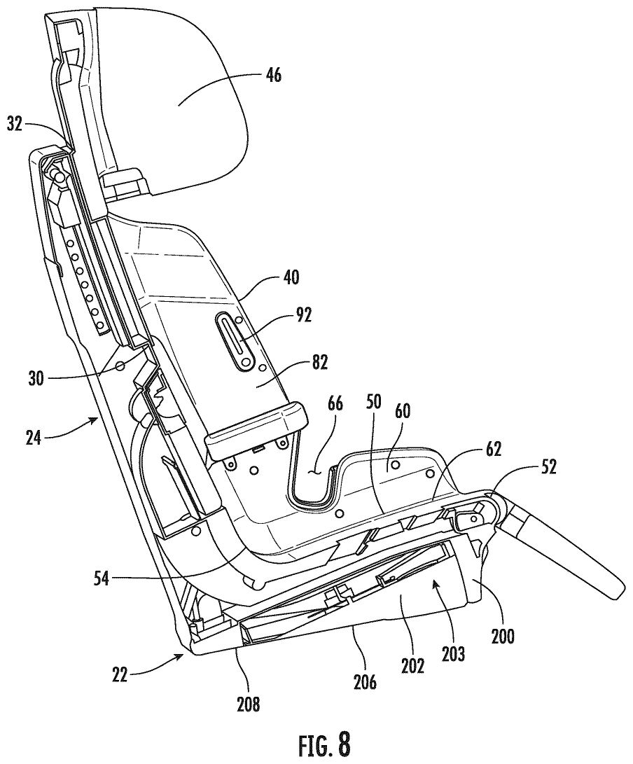

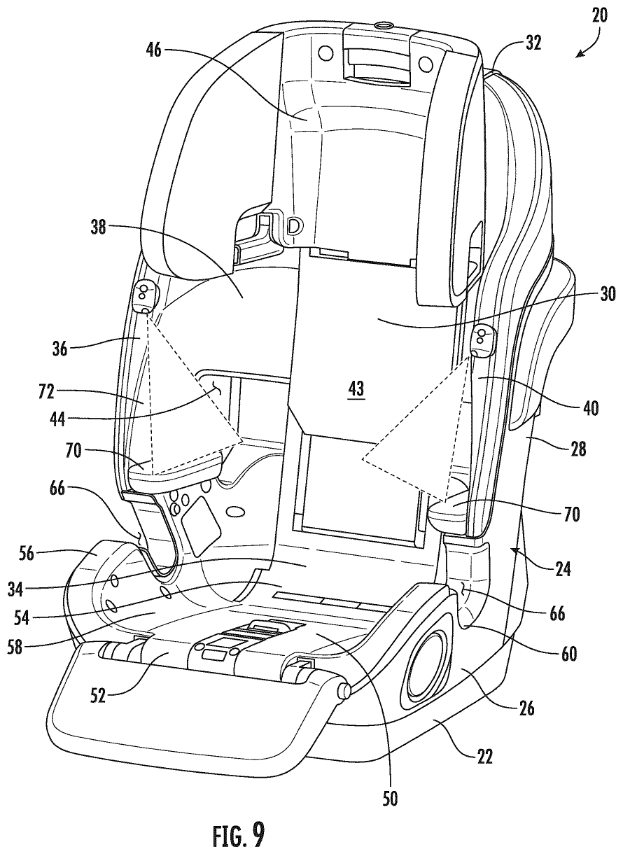

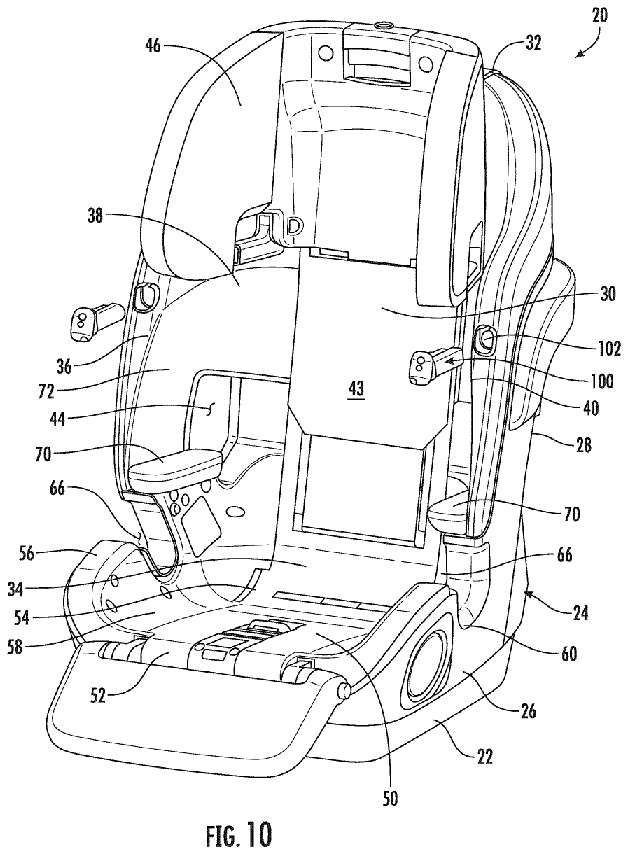

As best shown in FIGS. 1, 5, 6, 8, and 9, in an embodiment, the child safety seat includes at least one light 92. The at least one light 92 may be selectively operable to illuminate at least a portion of the upright support cavity 43 of the upright portion 28 within which an upper body of a child is received or directly in front of the upright support cavity 43. In the illustrated, non-limiting embodiment, shown in FIGS. 1, 5, 6, and 8, at least one light 92 is positioned at the inwardly facing surface 72 of each of the upright side members 36, 40. In another embodiment, illustrated in FIGS. 9 and 10, the at least one light 92 is arranged at a forward facing surface of the central portion 80 of a side member 36, 40. Although a single light 92 having an elongated configuration is shown in FIGS. 1, 5, 6, and 8, it should be appreciated that embodiments having a light 92 with another shape and embodiments having a plurality of lights are also within the scope of the disclosure. In an embodiment, the light 92 can include a variety of colors. For example, a child can select between a white light, blue light, yellow light, a combination of colored lights, or another color light. The child can select between colors by actuating a switch or other mechanism for controlling light (not shown) positioned, for example, on the curved surface 82. In embodiments where the upright side members 36, 40 include a cavity 74, the at least one light 92 may be positioned within the cavity, such as adjacent to a front edge of the upright side members 36, 40. However, embodiments having a light 92 arranged at another suitable location relative to the cavity 74 and/or the upright side members 36, 40 are also contemplated herein.

In an embodiment the child seat 20 includes one or more lights 92 that are permanently attached thereto. However, in other embodiments, such as shown in FIG. 10 for example, at least one light 92 is removably connectable to the child seat 20. Although only the lights 92 located at the side members 36, 40 of the child seat 20 are actually illustrated as being removable, it should be appreciated that a light arranged at any location about the child seat 20 may be permanently or removably coupled to the child seat 20.

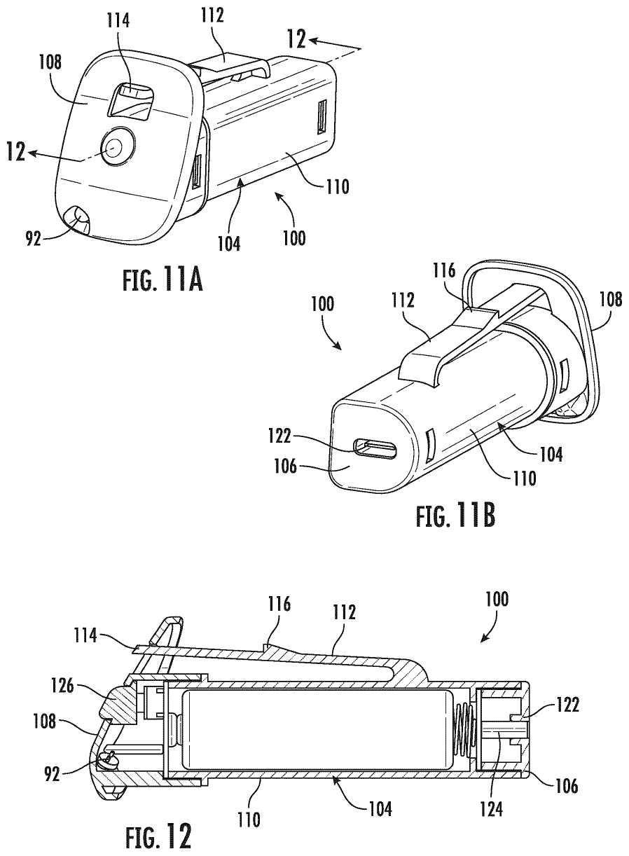

With reference to FIGS. 11A-12, an example of a removable light 92 is illustrated in more detail. In an embodiment, the light 92 may be integrated into an assembly 100, with the assembly 100 in its entirety being removably connectable to the child seat 20. The assembly 100 may be at least partially receivable within a corresponding socket or cavity 102 formed in a portion of the child seat 20, such as within a side members 36, 40 for example. In such embodiments, the light 92 is positioned at a location of the assembly 100 that is visible from and/or not arranged within the cavity 102.

In the illustrated, non-limiting embodiment, the assembly 100 includes a housing 104 having a first end 106, a second end 108, and at least one sidewall 110 extending between the first end 106 and the second end 108. To selectively couple the assembly 100 to the child seat 20, the housing 104 may include a resilient or flexible member 112. As shown, the flexible member 112 extends from the sidewall 110 to the second end 108 of the housing 104 such that a distal end 114 of the flexible member 112 is exposed at the second end 108. The bias of the flexible member 112 pushes the distal end 114 of the flexible member 112 radially outward from the sidewall 110. In some embodiments, a flange or catch 116 protrudes outwardly from a central portion of the flexible member 112.

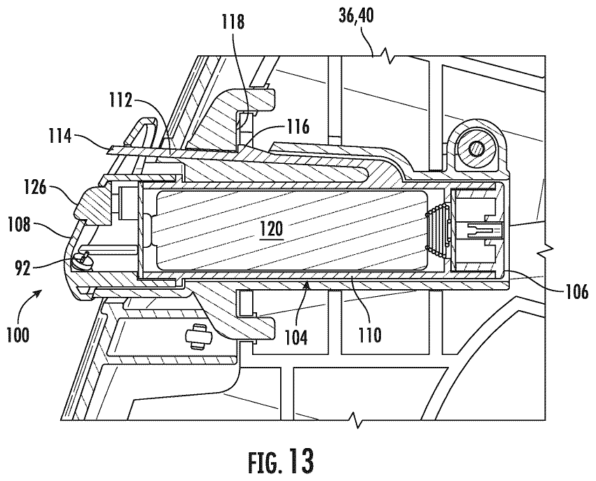

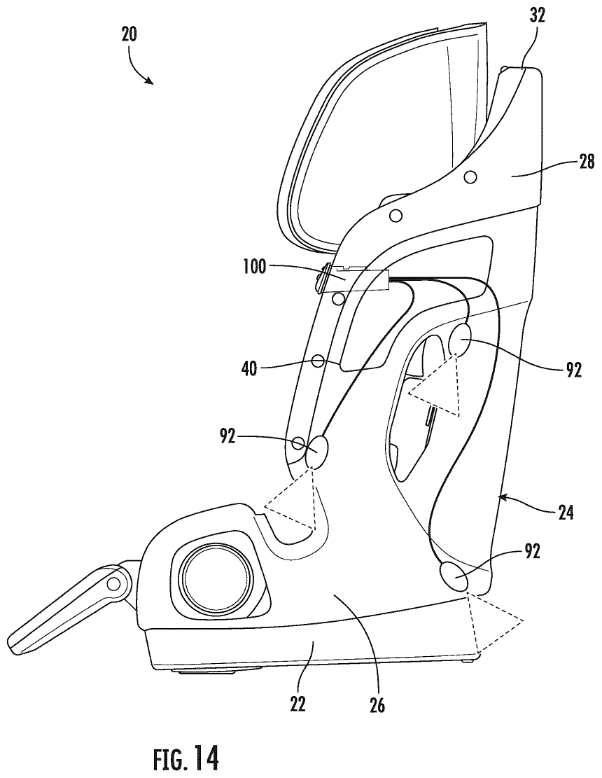

With reference to FIG. 13, when the assembly 100 is installed within a cavity 102 formed in the seat shell 24, the first end 106 of the housing 104 abuts an end of the cavity 102 and the second end 108 of the housing 104 is arranged near an adjacent exterior surface of the child seat 20, such as the forward-facing surface of the side member 36, 40 for example. During installation, the flexible member 112 is squeezed radially inward, towards the sidewall 110, against its bias. In this squeezed or compressed position, the catch 116 of the resilient member 112 is held out of a path of interference with the internal surface 118 of the cavity 102. Once the assembly 100 is fully inserted, the flexible member 112 is released. As a result of the bias, the distal end 114 of the flexible member 112 will move outwardly from the sidewall 110, thereby moving the catch into alignment with an adjacent internal surface 118 of the cavity 102. A surface of the catch contacts and abuts against the internal surface 118 of the cavity 102 thereby restricting movement of the assembly 100 from the cavity 102. To remove the assembly 100, the flexible member 112 is compressed towards the sidewall 110 to move the catch 116 out of alignment with the internal surface 118. It should be appreciated that the flexible member 112 and catch 116 illustrated and described herein is intended as an example only and that any suitable mechanism for selectively coupling the assembly to the child seat 20, including but not limited to a twist lock, a friction fit, or a threaded engagement for example, is contemplated herein.

The interior of the housing 104 may be generally hollow such that one or more additional components are positionable therein. In the non-limiting embodiment illustrated in FIG. 12, the assembly 100 includes a power source 120 for energizing the light 92 arranged within housing 104. The power source 120 may be replaceable, such as one or more batteries for example. In other embodiments, the power source 120 may be rechargeable, such as a rechargeable battery for example. In such embodiments, the power source 120 may be rechargeable upon removal from the assembly 100, or alternatively, may be rechargeable within the assembly 100. In embodiments where the power source 120 is rechargeable within the assembly 100, the assembly 100 includes a charging port 122 including corresponding charging circuitry 124, such as formed at the first end 106 of the housing 104 for example. Accordingly, when the assembly 100 is separated from the child seat 20, a charger, such as a USB charger for example, may be connected to the charging port 122 to recharge the power source 120. Although the assembly 100 is illustrated and described herein as including a light 92, it should be appreciated that embodiments where the assembly 100 does not have a light embedded therein are also contemplated herein. Rather, as will be described in more detail below, the assembly 100 may provide the power needed for a light 92 located remotely from the assembly 100.

The one or more lights 92 of the child seat 20 may be operable automatically, such as in response to an input. For example, the lights 92 may be activated or energized in response to operation or application of a force to a button, a switch, or other actuator located about the child seat 20. In the non-limiting embodiment illustrated in the FIGS., the assembly 100 includes a depressible button 126 located at the second end 108 of the housing 104, and application of a force to the button 126 may be used to selectively energize the light 92. In an embodiment, the one or more lights 92 may be operated or selectively energized for a predetermined period of time, such as via a timer. For example, the at least one light 92 may turn off automatically after 30 seconds, 45 seconds, a minute, or two minutes. In other embodiments, the same input used to energize the light 92, such as button 126 for example, or a different input may be used to selectively de-energize the light 92.

In an embodiment, the one or more lights 92 can be operably connected to one or more sensors (not shown). The one or more sensors can include, for example, a proximity sensor, a pressure sensor, or another sensor for sensing a proximity of the child seat 20 to a vehicle seat or stroller seat, or a position or movement of a component of the child seat 20. The one or more sensors can be configured to transmit a signal to the one or more lights 92 for activation and/or deactivation.

With reference to FIG. 14, in an embodiment, when the assembly 100 is installed within a cavity 102, the power source 120 embedded in the assembly 100 may be operably coupled to a plurality of lights 92 arranged at several different locations of the child seat 20, such as a light associated with a car seat belt path, or a light intended to assist in installation of the child seat 20 within a vehicle. Accordingly, operation of the light 92 embedded within the assembly 100, such as via the button 126 or a sensor for example, may similarly energize or deenergize one or more lights 92 associated with the child seat 20 and located remotely from the assembly 100. In addition, via the above-mentioned coupling with the plurality of lights 92, the power source 120 of the assembly 100 may function to provide power to the plurality of lights 92 when installed in the cavity 102.

In an embodiment, the assembly 100 is operable as a battery or power source for charging a portable device, including but not limited to a phone, tablet, computer, or watch for example. Accordingly, in some embodiments, the assembly 100 may be considered a portable device charger. In embodiments where the assembly is a portable device charger, the assembly 100 may but need not have a light 92. In such embodiments, a portable device may be electrically connectable to the power source 120 via a charging port formed in the housing 104. The charging port for coupling a portable device to the power source 120 may be the same charging port 122 used to recharge the power source 120 or may be separate therefrom. For example, in an embodiment, the charging port 122 used to recharge the power source 120 may be a USB Micro A or Micro B port and the charging port used to transfer power from the power source 120 to a portable device may be a USB-A port. In other embodiments, the housing 104 may include a plug or connector (not shown) receivable within a charging port of a portable device. In an embodiment, the charging port used to power a portable device may be located on the front face or second end 108 of the housing 104. Via such a position of the charging port, the assembly 100 may be used to charge a portable device not only when the assembly 100 is separated from the seat shell 24, but also when the assembly 100 is installed about the seat shell 24, such as within the

In an embodiment, at least a portion of the seat bottom 22 is movable to adjust an incline of the child safety seat 20. With reference to FIGS. 8, 15A-17, the seat bottom 22 includes a housing 200 and a support member 202 movable relative to the housing 200 between a plurality of positions including a first position, such as an inclined position, and a second position, such as a reclined position. However, it should be appreciated that the first position and the second position may both be positions arranged at an incline, the first and second positions having varying degrees of incline. Further, it should be appreciated that in some embodiments, the support member 202 may be arranged at one or more positions along the path of movement of the support member 202 between the first position and the second position to provide a greater degree of adjustability of the child safety seat 20. When the support member 202 is arranged in the first position, the support member 202 may be substantially or wholly positioned within the interior of the housing 200. In the first position, the bottom 206 of the support member 202 may be substantially flush with the bottom surface 208 of the housing 200. In the second position, at least a portion, and in some embodiments, a substantial majority of the support member 202 protrudes beyond the bottom surface 208 of the housing 200. In the second position, the bottom 206 of the support member 202 rather than the bottom surface 208 of the seat is configured to contact the vehicle seat.

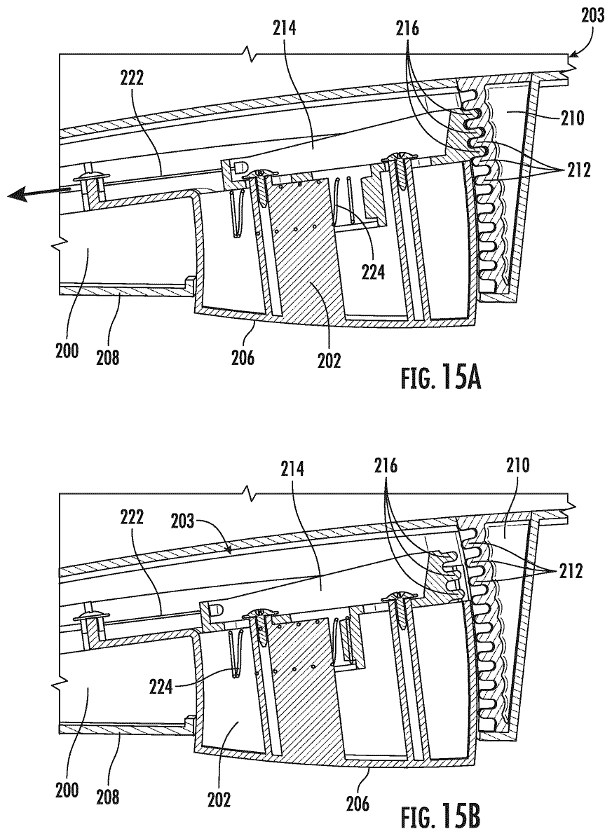

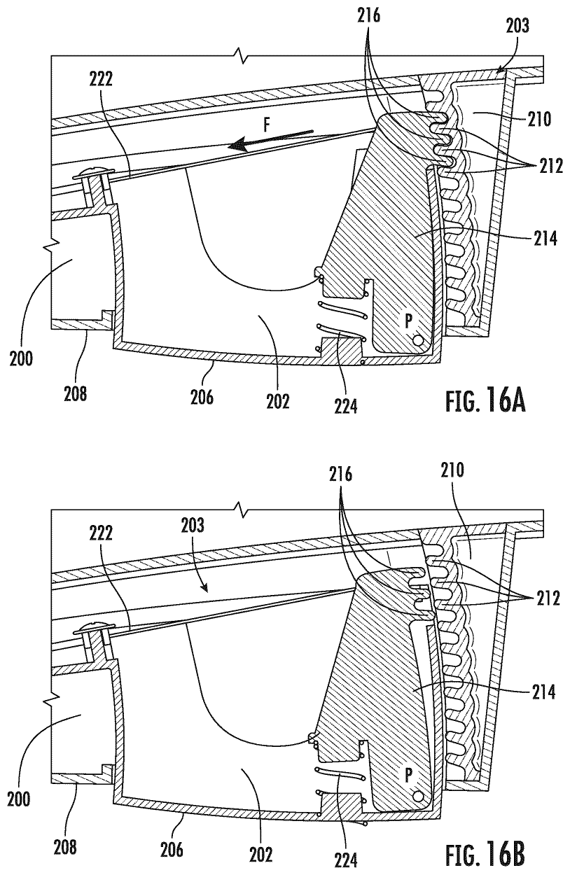

A mechanism 203 may be used to adjust an incline of the child safety seat 20 relative to the vehicle seat 10. The support member 202 may be selectively locked in the first position, the second position, or any position therebetween. With reference to FIGS. 15A-16B, in the illustrated, non-limiting embodiment, the mechanism 203 includes a rack 210 mounted within the interior of the housing 200 and having a plurality of first teeth 212. A catch 214 having at least one second tooth 216, and in some embodiments a plurality of second teeth, is attached to the support member 202. For example, the catch 214 may be mounted at or near an upper surface of the support member 202 as shown in FIG. 15A or may be mounted within the support member 202 adjacent to the rack 210 as shown in FIG. 16A. In each of the plurality of positions, the at least one second tooth 216 is intermeshed with the plurality of first teeth 212 to selectively lock the support member 202 relative to the housing 200.

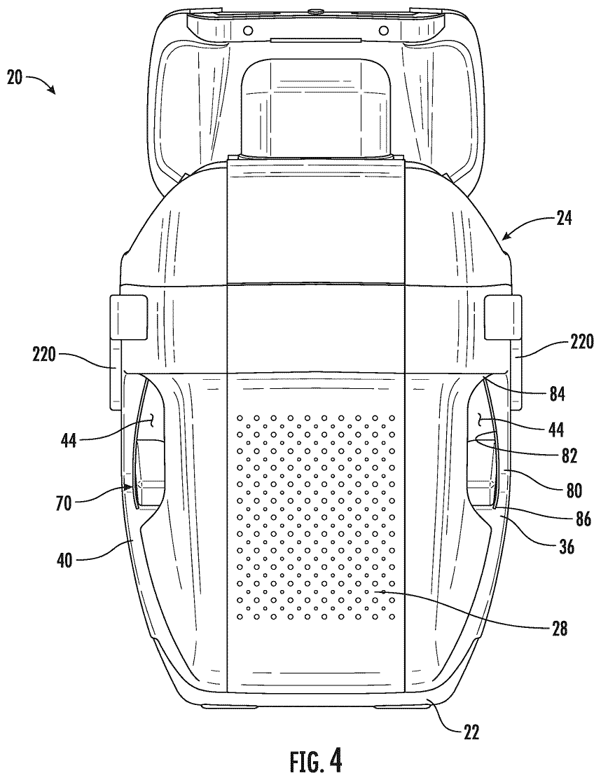

An actuator 220 operably coupled to the catch 214 may be located at an exterior surface of the child safety seat 20 at a position accessible by a user. In an embodiment, the actuator 220 (see FIG. 4) is located adjacent to an upright side member 36, 40 of the backrest portion 28 for example. Although the actuator 220 is illustrated as being at the backrest portion 28 of the seat shell 24, it should be understood that the actuator 220 may be located at any position easily accessible by a user when the child safety seat 20 is installed on a vehicle seat. For example, in an aspect, the actuator 220 can be positioned on at least one of the first and second upright side members 36, 40 and may extend into the respective openings 44. The user can access and actuate the actuator 220 by gripping the first and second upright side members 36, 40 and positioning their hands through the respective openings 44.

In the illustrated, non-limiting embodiment of FIGS. 15A and 15B, the catch 214 is configured to translate relative to the rack 210 in response to operation of the actuator 220. A force F is transmitted to the catch 214, such as via a cable, linkage, or other flexible member 222 for example, in response to operation of the actuator 220. This force F causes the at least one second tooth 216 of the catch 214 to disengage and separate from the plurality of first teeth 212 of the rack 210. In this separated configuration, the support member 202 may be moved relative to the housing 200 to adjust the angle of incline of the child safety seat 20. In an embodiment, a biasing member 224 is operably coupled to the catch 214 and is configured to bias the catch 214 into engagement with the rack 210. Accordingly, once the force F is removed from the actuator 220, the biasing force of the biasing member 224 will cause the catch 214 to translate and the at least one second tooth 216 to engage the plurality of first teeth 212, thereby locking the support member 202 in position relative to the housing 200.

In another embodiment, shown in FIGS. 16A and 16B, the catch 214 is configured to pivot about an axis P relative to the catch 214. In response to operation of the actuator 220, the force F transmitted to the catch 214 causes the catch 214 to pivot about the axis P, thereby separating the at least one second tooth 216 of the catch 214 from the plurality of first teeth 212 of the rack 210. In this separated configuration, the support member 202 is movable relative to the housing 200 to adjust the angle of incline of the child safety seat 20. Upon removal of the force from the actuator 220, the biasing force of the biasing member 224 will cause the catch 214 to pivot about the axis P, towards the rack 210. Although a vertically oriented spring 224 is illustrated, it should be appreciated that another biasing member 224 capable of causing the catch 214 to pivot about its axis P, such as a torsion spring for example is contemplated herein. The biasing force of the biasing member 224 pivots the at least one second tooth 216 of the catch 214 into engagement with the plurality of first teeth 212, thereby locking the support member 202 in position relative to the housing 200.

The actuator 220 can be configured to transition between an engaged position and a released position. In the engaged position, the actuator 220 is not actuated and the catch 214 is engaged with the rack 210 to lock the support member 202 in position. In the released position, the actuator 220 is actuated (e.g., compressed or rotated) and the catch 214 is separated from the rack 210 and the support member 202 is movable relative to the housing 200 to adjust the incline of the child safety seat 20.

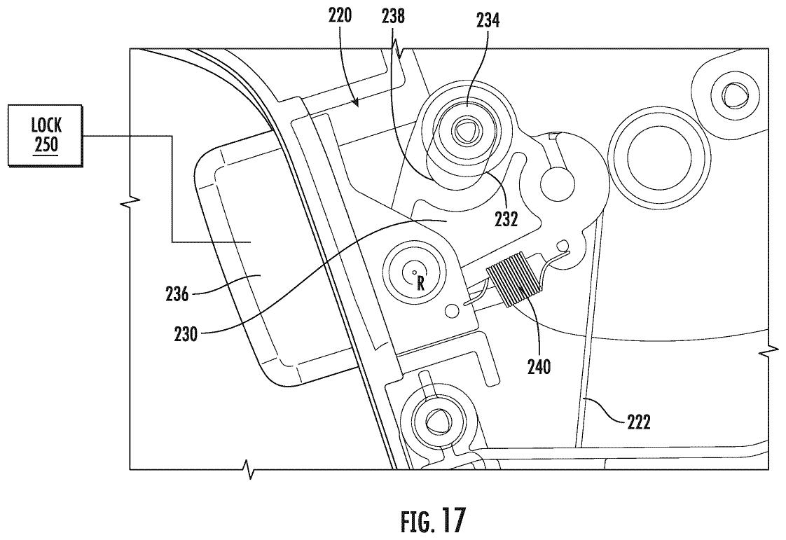

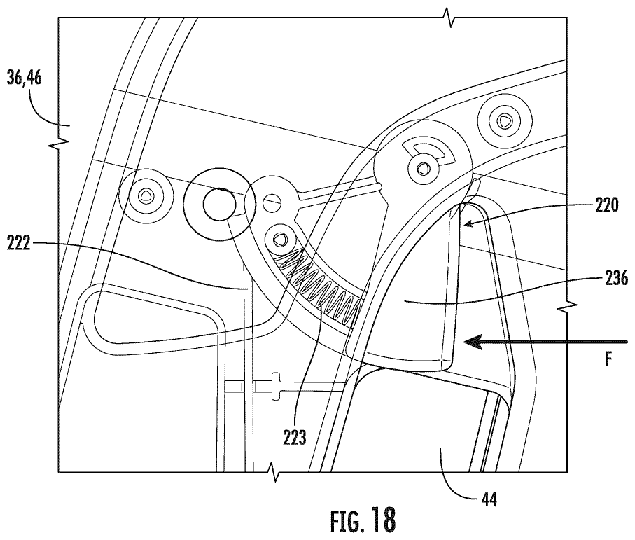

With reference now to FIG. 17, an example of an actuator 220 according to an embodiment is illustrated in more detail. As shown, the actuator 220 includes a pivot member 230 connected to the flexible member 222. The pivot member 230 may have a slot 232 formed therein and a pin or other member 234 extending from an interior surface of the seat shell 24 is received within the slot 232. Accordingly, the pivot member 230 is translatable relative to the pin 234. An engagement member 236, such as a depressible button for example, protrudes through an opening in the seat shell 24. The engagement member 236 is operably coupled to the pivot member 230. In an embodiment, the pivot member 230 is configured to rotate about a pivot axis R relative to the engagement member 236.

To operate the actuator 220, a force F is applied to the engagement member 236 in a first direction. This force F causes the engagement member 236 to translate inwardly in the same first direction into the seat shell 24, from the engaged position to the released position. As the engagement member 236 translates, the pivot member 230 rotates relative to the engagement member 236 about the pivot axis R. During this rotation, the pivot member 230 is also configured to translate relative to the seat shell 24, causing the pin 234 to move from a position near a first end of the slot 232 (FIG. 17) to a position near a second, opposite end 238 of the slot 232. As a result of the rotation of the pivot member 230 about pivot axis R, the translation of the pivot member 230 occurs in a second direction, distinct from the first direction. The second direction or the direction of translation of the pivot member 230 is arranged at an angle relative to direction of movement of the engagement member 236, or the direction of the force F applied to the engagement member 236. In an embodiment, the second direction is arranged generally perpendicular to the first direction. This movement of the pivot member 230 in the second direction applies a force to the flexible member 222, causing the catch 214 to disengage from the rack 210 as previously described.

In an embodiment, a biasing member 240, such as a coil spring for example, extends between the engagement member 236 and the pivot member 230. Upon removing the force F from the engagement member 236, gravity and/or the biasing force of the biasing member 240 will cause the pivot member 230 to translate relative to the seat shell and rotate relative to the engagement member 236. This translation and rotation of the pivot member 230 causes the engagement member 236 to translate outwardly to the engaged position.

Another example of the actuator 220 associated with the mechanism 203 is illustrated in more detail in FIG. 18. In an embodiment, the actuator 220 includes an engagement member 236 that is pivotally mounted to the seat shell 24. The engagement member 236 may be rotatable inwardly into an interior of the seat shell 24 when rotated about its axis A from the engaged position to the released position. However, embodiments where the actuator is rotatable relative to the seat shell 24 in another orientation are also contemplated herein.

A cable, linkage, or other flexible member 222 for example, is coupled to the engagement member 236. In the illustrated, non-limiting embodiment, the flexible member 222 is directly coupled to the engagement member 236. As the engagement member 236 is rotated about its axis A from the engaged position to the released position in response to application of a force F thereto, the force is transmitted to the flexible member 222. The flexible member 222 may also be connected to the support member 202 to move the support member relative to the housing 200 to adjust the angle of incline of the child safety seat 20. A biasing member 223 is operably coupled to the actuator 220 such that a biasing force of the biasing member 223 biases the actuator 220 to the first, unactuated position. In the illustrated, non-limiting embodiment, the biasing member 223 is a coil spring positioned between the seat shell 24 and a surface of the actuator 220; however, embodiments where the biasing member 223 is arranged at another location, or has another configuration, such as a torsion spring aligned with the axis A for example, are also contemplated herein.

Regardless of the construction of the actuator 220, an actuator lock 250 is operably connected to the actuator 220. The actuator lock 250 may be configured to releasably lock the actuator 220 in the release position. For example, when a user transitions the actuator 220 from the engaged position to the release position by operating the actuator 220, the user can lock the actuator 220 in the release position so that the support member 202 is movable relative to the housing 200 even after the user removes the force from the actuator 220. If the actuator is locked in the release position when the child safety seat 20 is installed on a vehicle seat 10, the recline of the child safety seat 20 may be configured to automatically adapt to the recline of the vehicle seat as the vehicle seatback angle of the vehicle seat is adjusted. Once the support member 202 is positioned on the vehicle seat 10 with the child safety seat 20 at a desired angle, the actuator lock 250 can be unlocked to transition the actuator 220 to the engaged position, thereby locking the support member 202 in position. Although the actuator lock 250 is described herein as being operable to lock the actuator 220 in the release position, it should be understood that the actuator lock 250 may additionally or alternatively be operable to lock the actuator 220 in the engaged position, such as to prevent the intentional release thereof.

The mechanism 203 for adjusting the angle of incline of the child safety seat 20 as described herein allows a user to adjust the angle of incline of the child safety seat 20 after the child safety seat 20 has been positioned on and coupled to the vehicle seat 10, either via a vehicle restraint or the LATCH system. In the event that an angle of the vehicle seat 10 is adjusted, the child safety seat 20 does not have to be removed and recoupled to the vehicle seat 10. Instead, the mechanism 203 allows the child safety seat 20 to be inclined and reclined without disengaging the vehicle restraint or the LATCH system.

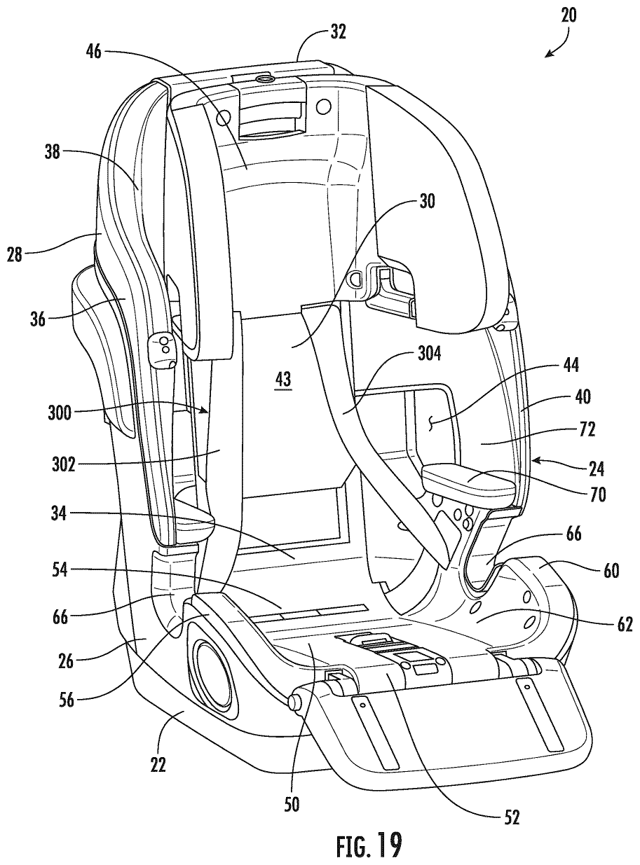

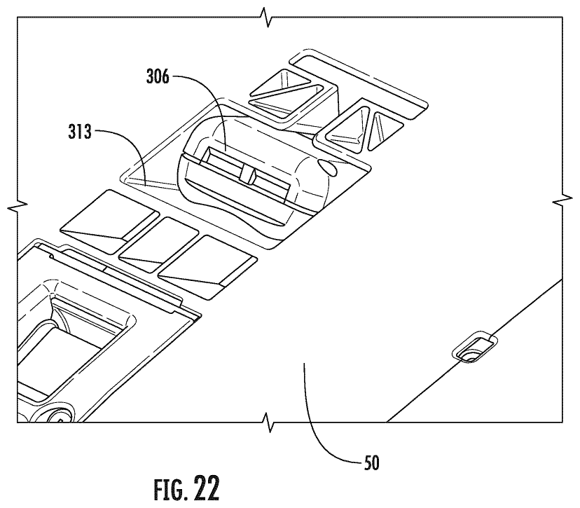

With reference now to FIG. 19, in an embodiment, the seat shell 24 of the child seat 20 includes a harness 300, separate from the vehicle belt, for securing a child within the child seat 20. In the illustrated, non-limiting embodiment, the harness 300 includes two straps 302, 304 with clips (not shown) that are both connectable to a buckle 306 (see FIG. 22), such as mounted to a crotch strap (not shown), to form both shoulder and lap straps about a child positioned within the child seat 20. The shoulder portions of the straps 302, 304 may additionally include respective portions of a clip or buckle (not shown) connectable to each other across an occupant's chest.

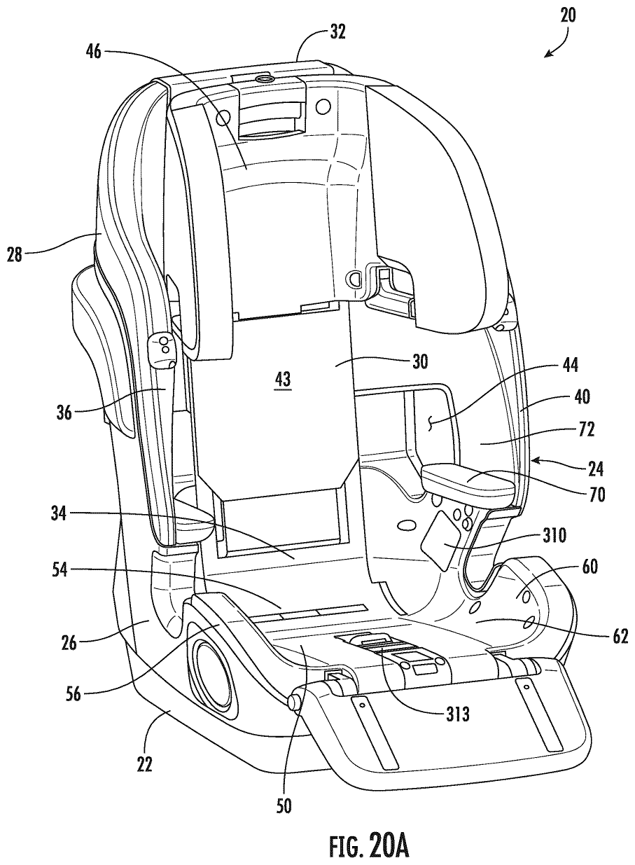

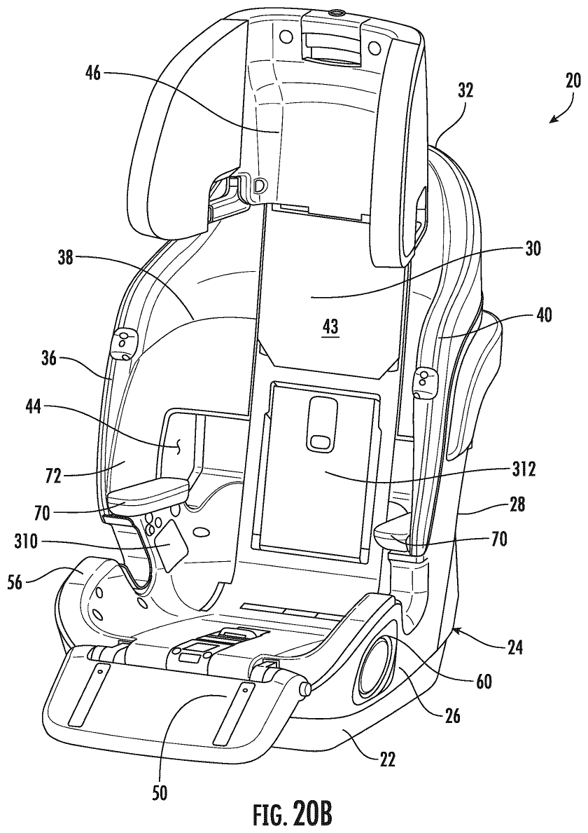

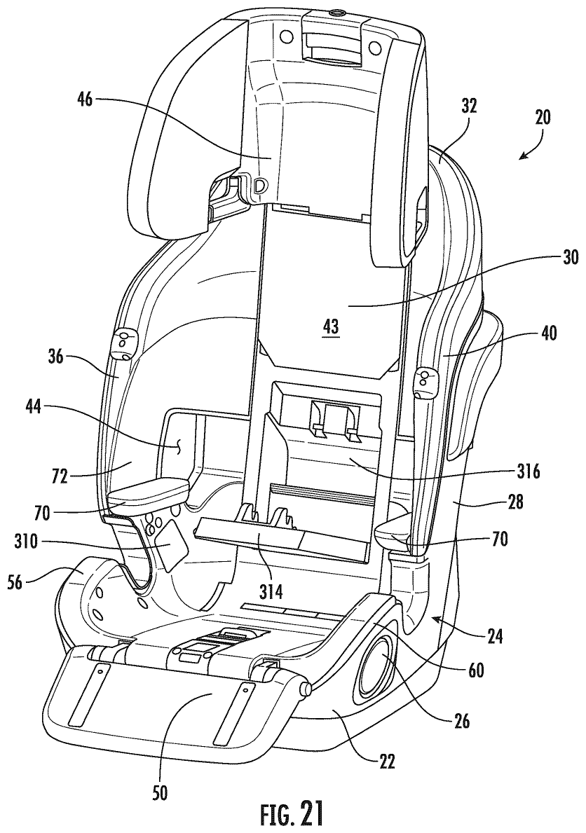

When the child seat 20 is converted to a high back booster, the harness of the child seat 20 is removed or stored out of the way of the upright support cavity 43 and/or the region 64 within which at least part of a lower body of a child is received. Accordingly, in an embodiment, the seat shell 24 may include one or more storage compartments or pockets for stowing all or a portion of the harness out of the way of cavity 43 and region 64. For example, at least one of the side members 36, 40 of the seat shell 24, such as at a location beneath the armrest 70 for example, includes a pocket or compartment 310. In the illustrated, non-limiting embodiment of FIGS. 20A and 20B, a compartment 310 is formed in each side member 36, 40. Alternatively, or in addition, the support surface 30 of the seat back 28 includes at least one compartment (see FIG. 20B). A compartment 313 may be arranged in the support surface 50 of the seat bottom 26. However, it should be appreciated that a compartment arranged at any suitable location about the child seat 20 to receive or stow a portion of the harness 300 or LATCH system, therein is within the scope of the disclosure. The compartments 310, 312 may be open, or may have movable doors for selectively accessing the interior of the compartments.

To stow the harness 300, a user will loosen the harness 300 and place a respective strap 302, 304 and buckle and/or chest clip in a corresponding compartment 310, such as formed in the side members 36, 40 for example. Similarly, a crotch strap and buckle 306 of the harness 300 may be retracted into the compartment 313 formed in the support surface 50. The latches (not shown) used to secure the child seat 20 to the vehicle seat 10 when the child seat 20 is configured as a booster may be stored within the compartment 312 arranged in the seat back 28, such as the support surface 30 for example.

In the illustrated, non-limiting embodiment of FIGS. 20B and 21, the compartment 312 includes a door 314 movable to access an interior 316 thereof. In an embodiment, the compartment 312 is operable as a belt lock off for securing the child seat 20 to the vehicle seat 10 using the vehicle belt. The vehicle belt is fed behind the door 314 and the door 314 is then closed to lock the vehicle belt to the child seat 20.

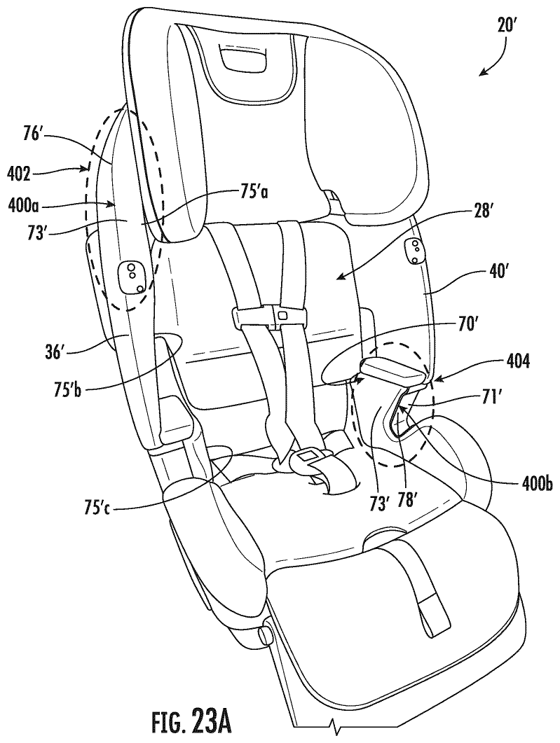

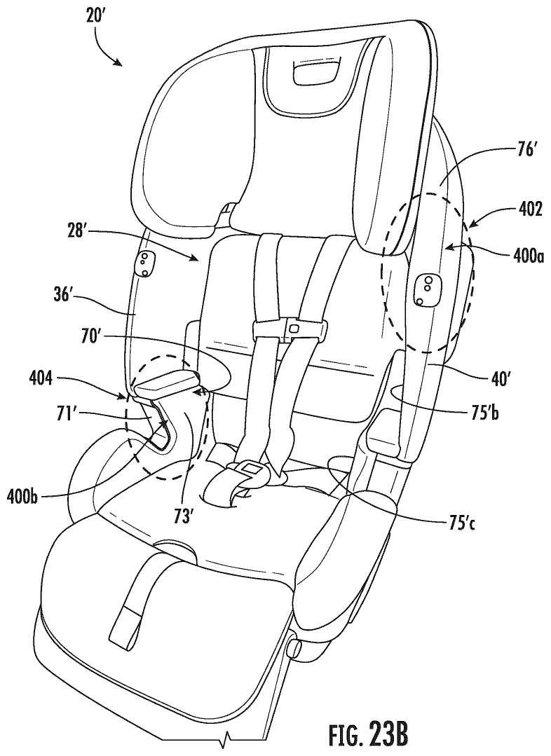

FIGS. 23A and 23B illustrate a child safety seat 20′ having soft goods at least partially positioned thereon, according to an aspect of this disclosure. Portions of the alternate aspect of the child safety seat 20′ disclosed in FIGS. 23A and 23B are similar to aspects of the child safety seat 20 described above in FIGS. 1-22 and those portions function similarly to those described above. The child safety seat 20′ includes an armrest 70′ positioned within an interior of the child safety seat 20′. The armrest 70′ is positioned above a support portion 71′. In an aspect, the support portion 71′ is be formed integrally with a seat shell of the child safety seat 20′. In an alternative or additional aspect, the support portion 71′ can be positioned directly below the armrest 70′. The support portion 71′ is configured to receive and/or support a padding or soft goods 73′ thereon. The padding or soft goods 73′ can help support, for example, the hips of a child positioned on the child safety seat 20′.

With reference now to FIGS. 23A, 23B, 24, and 25 a child safety seat such as seats 20 or 20′ may further be designed to provide improved side impact protection to an occupant of the seat 20, 20′. Side impact protection as used herein is intended to describe protection for an occupant involved in a crash or impact at a side of the vehicle, such as at or near a vehicle door for example. The child safety seat 20 or 20′ as shown may include at least one side impact protector, and in some embodiments includes a plurality of side impact protectors (shown as 400a, 400b) arranged about the seat 20, 20′. In an exemplary embodiment, the one or more side impact protectors 400a, 400b are one or more protruding structures that extend into the upright support cavity 43 at a greater distance than portions of the seat 20, 20′ proximate the side impact protectors 400a, 400b.

An exemplary embodiment of a side impact protector is shown in FIGS. 23A-25 as a shoulder impact protector 400a, which is arranged at or near the area of the seat 20, 20′ located adjacent to an occupant's shoulders. As shown in FIGS. 23A-25, the shoulder impact protector 400a is disposed at an upper region 402 of at least one or both of the first and second upright side members 36, 40 or 36′, 40′ of the seat shell 24. As shown, this upper region 402 includes at least part of the first end portion 76 or 76′. In some embodiments, the upper region 402 may alternatively or additionally include a portion of the central region 80 or 80′, such as proximate to the first end portion 76, 76′. However, it should be understood that any suitable portion of the upright portion 28 may be designed as part of the shoulder impact protector.

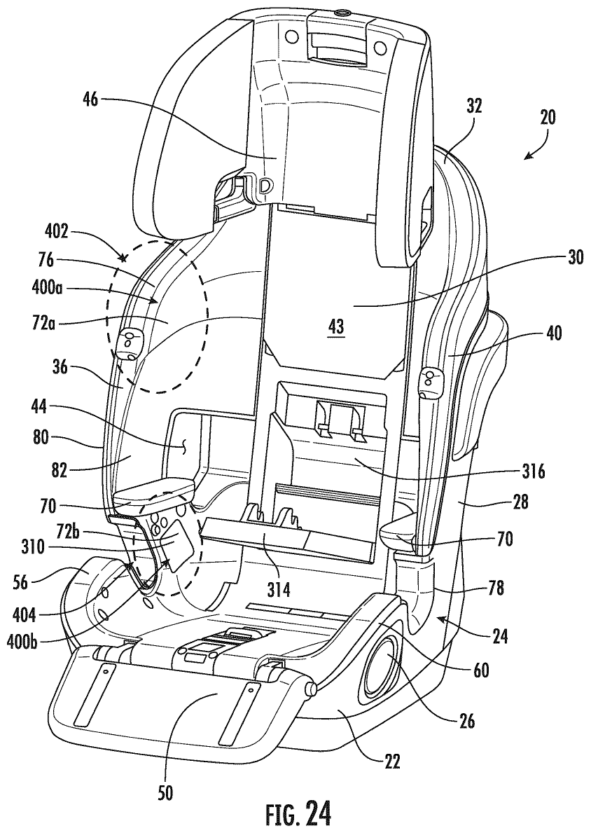

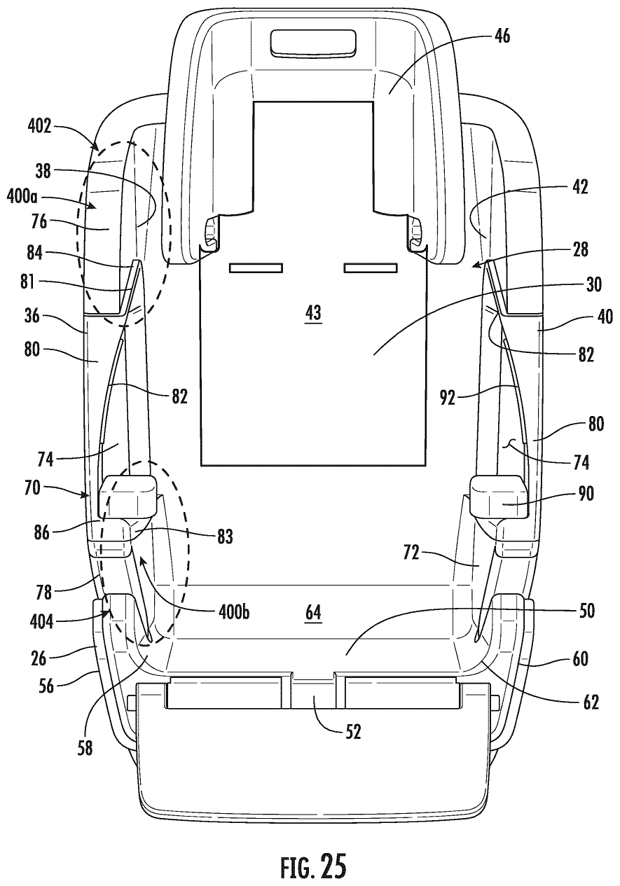

The shoulder impact protector 400a may be formed by an inwardly extending contour of the seat shell 24 (see FIG. 24), and/or by inwardly extending padding or soft goods, such as soft goods 73′ (FIGS. 23A and 23B) for example. In some embodiments, the shoulder impact protector 400a may additionally or alternatively be formed by a portion of the central region 80. In an embodiment, such as that shown in FIG. 25, the central region 80 includes a flange 81 that is arranged at a relatively upper end 84 of the central region part 80 and extends inwardly toward the upright support cavity 43.

The shoulder impact protector 400a extends or protrudes into the upright support cavity 43 to restrict or decrease chest displacement of the occupant during a side impact event. Via this extension into the upright support cavity 43, an inwardly facing surface of the shoulder impact protector 400a at the upper region 402 is laterally offset from the inwardly facing surface of an adjacent portion of the first and second upright side members 36, 40. For example, as shown in FIG. 24 the inwardly facing surface 72a of the seat shell 24 at the first end portion 76 of the upright side members 36, 40 may form the shoulder impact protector 400a. This surface 72 extends further towards the interior of the upright support cavity 43 than the inwardly facing surface 82 of an adjacent region of the upright side member 36, 40, such as that of the central portion 80 of the seat shell 24 in FIG. 24 for example. Similarly, as shown in FIGS. 23A and 23B, the inwardly facing surface 75′a defined by the soft goods 73′ at the upper region 402 of an upright side member 36′, 40′ may also form the shoulder impact protector 400a. This surface 75′a extends further inwardly toward the center of the upright support cavity 43 than the inwardly facing surface 75′b of the soft goods 73′ at an adjacent region of an upright side member 36, 40. In the non-limiting embodiment of FIG. 25, the flange 81 arranged at the upper end 84 of the central portion 80 also similarly extends further towards the interior of the upright support cavity 43 than the inwardly facing surface 82 of an adjacent section of the central portion 80. It should be appreciated that the protrusion of the shoulder impact protector 400a towards the interior of the upright support cavity 43, such as shown in FIGS. 23A and 23B, may be a result of one or more or the contour of the seat shell 24, the build-up of soft goods 73, and the positioning of an additional component, such as the flange 81 of FIG. 25 under the material of the surface 75a.

Alternatively, or in addition to the shoulder impact protector 400a described above, a side impact protector is shown in FIGS. 23A-25 as a hip impact protector 400b, which is arranged at or near the area of the seat 20, 20′ located adjacent to an occupant's hips. In an embodiment, the hip impact protector 400b is disposed at a lower region 404 of at least one or both of the first and second upright side members 36, 40 or 36′, 40′. As shown, this lower region 404 includes at least part of the second end portion 78 or 78′. In some embodiments, the lower region 404 may alternatively or additionally include a portion of the central region 80 or 80′, such as proximate to the second end portion 78, 78′. However, it should be understood that any suitable portion of the upright portion 28 may be designed as part of the hip impact protector 400b.

The hip impact protector 400b may be formed by a contour of the seat shell 24 (see FIG. 24) and/or by padding or soft goods, such as soft goods 73′ (FIGS. 23A and 23B) for example. In some embodiments, the hip impact protector 400b may additionally or alternatively be formed by a portion of the central region 80, 80′. For example, an end of the central region 80 proximate the second end portion 78 may include a shelf 83 that protrudes inwardly toward a center of the upright support cavity 43.

A hip impact protector 400b may extend or protrude into the upright support cavity 43 to restrict or decrease chest displacement of the occupant during a side impact event. Via this extension into the upright support cavity 43, an inwardly facing surface at the hip impact protector 400b is laterally offset from the inwardly facing surface of an adjacent portion of the first and/or second upright side members 36, 40. For example, as shown in FIG. 24 the inwardly facing surface 72b at the second end portion 78 of an upright side member 36, 40 may form the hip impact protector 400b. This surface 72b may be laterally offset from an inwardly facing surface of an adjacent region of the upright side member 36, 40. In the illustrated, non-limiting embodiment, the inwardly facing surface 72b at the second end portion 78 extends further towards the upright support cavity 43 than the inwardly facing surface 82 of the adjacent region of the upright side member 36, 40. Similarly, with reference to FIGS. 23A and 23B, the inwardly facing surface 75′c of the soft goods 73′ at the lower region of an upright side member 36′, 40′ may also form the hip impact protector 400b. This surface 75′c may laterally extend further inwardly into the upright support cavity 43 than an inwardly facing surface 75′b of the soft goods 73′ arranged at an adjacent portion of the upright side member 36, 40, such as between the upper and lower regions 402, 404 for example. In the non-limiting embodiment of FIG. 25, the shelf 83 arranged at an end of the central portion 80 located adjacent to the lower region 404 similarly extends further towards the interior of the upright support cavity 43 than the inwardly facing surface 82 of an adjacent region of the central portion 80. It should be appreciated that the protrusion of the hip impact protector 400b towards the interior of the upright support cavity 43, such as shown in FIGS. 23A and 23B, may be a result of one or more or the contour of the seat shell 24, the build-up of soft goods 73, and the positioning of an additional component, such as the flange 83 of FIG. 25 under the material of surface 75′c.

In addition to restricting chest displacement, inclusion of at least one side impact protector (such as 400a and/or 400b for example) at the seat 20, 20′ near or aligned with the shoulder and/or hip areas of a child seated therein may also decrease the head injury criterion or specific head movement of an occupant that occurs during a side impact event. It should be understood that although the side impact protectors 400a, 400b are described as being located at the shoulder and hip areas of the seat 20, 20′, embodiments including a side impact protector located at another area of the seat 20, 20′ are also within the scope of the disclosure. Further, any combination of side impact protectors is contemplated herein. It should be appreciated that the first upright side member 36 may have similar, or alternatively, may have different side impact protectors than the second upright side member 40. For example, the first upright side member 36, 36′ may include no impact protector, or one or both of a shoulder impact protector 400a and a hip impact protector 400b. Similarly, regardless of the configuration of the impact protectors at the first upright side member 36, 36′, the second upright side member 40, 40′ may have no impact protector or may have one or both of a shoulder and hip impact protector 400a, 400b.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A child safety seat comprising:
a seat shell including:
an upright support surface including a first side and a second side;
a first upright side member arranged at said first side and extending forward from said upright support surface, and a second upright side member arranged at said second side and extending forward from said upright support surface;
an upright support cavity for receiving an upper body of a child, said upright support cavity being defined between said upright support surface, said first upright side member and said second upright side member; and
at least one armrest located within said upright support cavity.

2. The child safety seat of claim 1, wherein said at least one armrest is located at said at least one of said first upright side member and said second upright side member.

3. The child safety seat of claim 2, wherein said at least one armrest is arranged at an inwardly facing surface of said at least one of said first upright side member and said second upright side member.

4. The child safety seat of claim 3, wherein said at least one armrest further comprises a support surface, said support surface being formed by a lateral offset in said inwardly facing surface of said at least one of said first upright side member and said second upright side member.

5. The child safety seat of claim 4, further comprising a pad mounted in overlapping arrangement with said support surface.

6. The child safety seat of claim 5, wherein said pad protrudes in at least one direction beyond said support surface.

7. The child safety seat of claim 3, wherein a cavity is formed in said inwardly facing surface of said at least one of said first upright side member and said second upright side member, said at least one armrest being arranged within said cavity.

8. The child safety seat of claim 7, wherein said cavity includes a curved surface and said at least one armrest is arranged at an end of said curved surface.

9. The child safety seat of claim 1 wherein said seat shell further comprises:
a seat support surface including another first side and another second side;
a first seat side member arranged at said another first side and extending upward from said seat support surface and a second seat side member arranged at said second side and extending upward from said seat support surface.

10. The child safety seat of claim 9, wherein said first seat side member and said first upright side member are integrally formed and said second seat side member and said second upright side member are integrally formed.

11. The child safety seat of claim 9, wherein each of said first seat side member and said second seat side member has a slot formed therein for receiving a vehicle restraint.

12. The child safety seat of claim 11, wherein said at least one armrest is positioned behind the slot.

13. The child safety seat of claim 1, further comprising a seat bottom, said seat shell being permanently connected to said seat bottom.

14-57. (canceled)

58. A seat shell for a child safety seat, the seat shell comprising:
a seat portion;
an upright back portion extending from said seat portion;
a first upright side member arranged at a first side of said upright back portion; and
a second upright side member arranged at a second side of said upright back portion,
wherein each of said first upright side member and said second upright side member includes a first end portion, a second end portion positioned below said first end portion, a central portion positioned between said first end portion and said second end portion, and an inwardly facing surface extending from said first end portion to said second end portion, and
wherein said inwardly facing surface on said second end portion of said first upright side member and said second upright side member are laterally offset towards an interior of the seat shell relative to said inwardly facing surface of said central portion of said first upright side member and said second upright side member.

59. The seat shell of claim 58, wherein said second end portion of said first upright side member and said second upright side member are positioned adjacent to said seat portion.

60. The seat shell of claim 58, wherein at least one armrest is arranged on said inwardly facing surface of at least one of said first upright side member and said second upright side member.

61. The seat shell of claim 60, wherein said at least one armrest is formed by said lateral offset of at least one of said inwardly facing surfaces of said second end portions.

62. The seat shell of claim 58, wherein a cavity is formed in a portion of at least one of said inwardly facing surface of at least one of said first upright side member and said second upright side member.

63. The seat shell of claim 62, wherein said cavity is formed on said central portion of at least one of said first upright side member and said second upright side member.

64. The seat shell of claim 63, wherein said inwardly facing surface on said central portion of at least one of said first upright side member and said second upright side member is a curved surface defining said cavity.

65. The seat shell of claim 63, wherein said inwardly facing surface on said central portion of at least one of said first upright side member and said second upright side member extends outwardly away from said interior of the seat shell relative to said first end portion and said second end portion.

66. The seat shell of claim 65, wherein said inwardly facing surface on said central portion of at least one of said first upright side member and said second upright side member extends from an approximate shoulder height of a child positioned in said child safety seat to an approximate waist height of said child seated within said child safety seat.

67. The seat shell of claim 66, wherein said cavity is formed between said approximate shoulder height and said approximate waist height.

68. A seat shell for a child safety seat, the seat shell comprising:
a seat portion;
an upright back portion extending from said seat portion; and
at least one upright side member arranged at a side of said upright back portion, said at least one upright side member including:
a first end portion,
a second end portion positioned below said first end portion,
a central portion positioned between said first end portion and said second end portion, and
an inwardly facing surface on said first end portion and said second end portion,
wherein said inwardly facing surface on said first and said second end portions is laterally offset towards an interior of the seat shell relative to said central portion.

69. The seat shell of claim 68, wherein said central portion comprises at least one of a cavity and a void.

70. The seat shell of claim 68, wherein said central portion extends from said first end portion to said second end portion.

71. The seat shell of claim 70, wherein said central portion includes an inwardly facing curved surface.

72. The seat shell of claim 71, wherein said inwardly facing curved surface extends outwardly from said interior from said first end portion to said second end portion, said inwardly facing curved surface defining a cavity between said first end portion and said second end portion.

73. The seat shell of claim 68, wherein said first end portion is positioned at a first height such that when a child is positioned within said child safety seat said inwardly facing surface of said first end portion approximately aligns with a shoulder of said child, and wherein said second end portion is positioned at a second height such that when said child is positioned within said child safety seat said inwardly facing surface of said second end portion approximately aligns with a hip of said child.

74. The seat shell of claim 73, wherein said central portion extends from said first end portion to said second end portion and defines a cavity therebetween, wherein said cavity is sized such that when said child is positioned within said child safety seat an arm of said child is at least partially receivable within said cavity.

75. The seat shell of claim 68, wherein said inwardly facing surface of at least one of said first end portion and said second end portion defines a planar surface.

76. A seat shell for a child safety seat, the seat shell comprising:
a seat portion;
an upright back portion extending from said seat portion;
at least one upright side member arranged at a side of said upright back portion, said at least one upright side member having an inwardly facing upright surface; and
at least one side seat member arranged at a side of said seat portion and adjacent to said at least one upright side member, said at least one side seat member having an inwardly facing side surface;
wherein said inwardly facing upright surface is laterally offset towards an interior of the seat shell relative to said inwardly facing side surface.

77. The seat shell of claim 76, wherein said at least one upright side member is positioned between said upright back portion and said at least one side seat member in a front direction.

78-90. (canceled)
